(19) United States
(12) Patent Application Publication
(10) Pub. No.: US 2016/0119458 A1
(43) Pub. Date: Apr. 28, 2016

(54) CLAMP DEVICE

(71) Applicant: LITE-ON TECHNOLOGY CORPORATION, Taipei (TW)

(72) Inventors: Daniel GÜNTHER, Taipei (TW); Helmut SCHERER, Taipei (TW)

(73) Assignee: LITE-ON TECHNOLOGY CORPORATION, Taipei (TW)

(21) Appl. No.: 14/526,419

(22) Filed: Oct. 28, 2014

(51) Int. Cl. H04M 1/04; F16B 2/10

(52) U.S. Cl. CPC H04M 1/04; F16B 2/10

(57) ABSTRACT

A clamp device for carrying a communication device comprises a compartment and a clamp. The compartment has a flat surface. The clamp is pivotally connected to the compartment and has a pressing line for contacting a surface edge of the communication device to fix the communication device on the compartment.

### BACKGROUND OF THE INVENTION

1. Field of the Invention

The invention relates in general to a clamp device, and more particularly to a clamp device for fixing a communication device.

2. Description of the Related Art

The quality of the display is a crucial issue of smart-phones. Although the latest developments lead to scratch resistant glass coatings, a manual clamp that presses on a particular area of the display surface every day will still leave a scratched area. Considering the smart-phones may be placed on a clamp device for being fixed, the dust and dirt particles on the phone or the clamp will harm the display even more.

Currently, available clamps in the market (like the BMW universal snap-in-adapter) handle the smart-phones in a variety of sizes but harm the displays of smart-phones by pressing them directly.

### SUMMARY OF THE INVENTION

One aspect of the present invention relates to a clamp device for fixing communication device which has a panel.

According to one of the embodiments of the present invention, a clamp device for carrying a communication device comprises a compartment; and a clamp pivotally connecting to the compartment and having a pressing line for contacting a surface edge of the communication device to fix the communication device on the compartment.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 is a schematic diagram of a clamp device according to an embodiment of the invention;

FIG. 2 is a side view of the clamp device of FIG. 1; and

FIG. 3 is a schematic diagram of a clamp of the clamp device of FIG. 1.

### DETAILED DESCRIPTION OF THE INVENTION

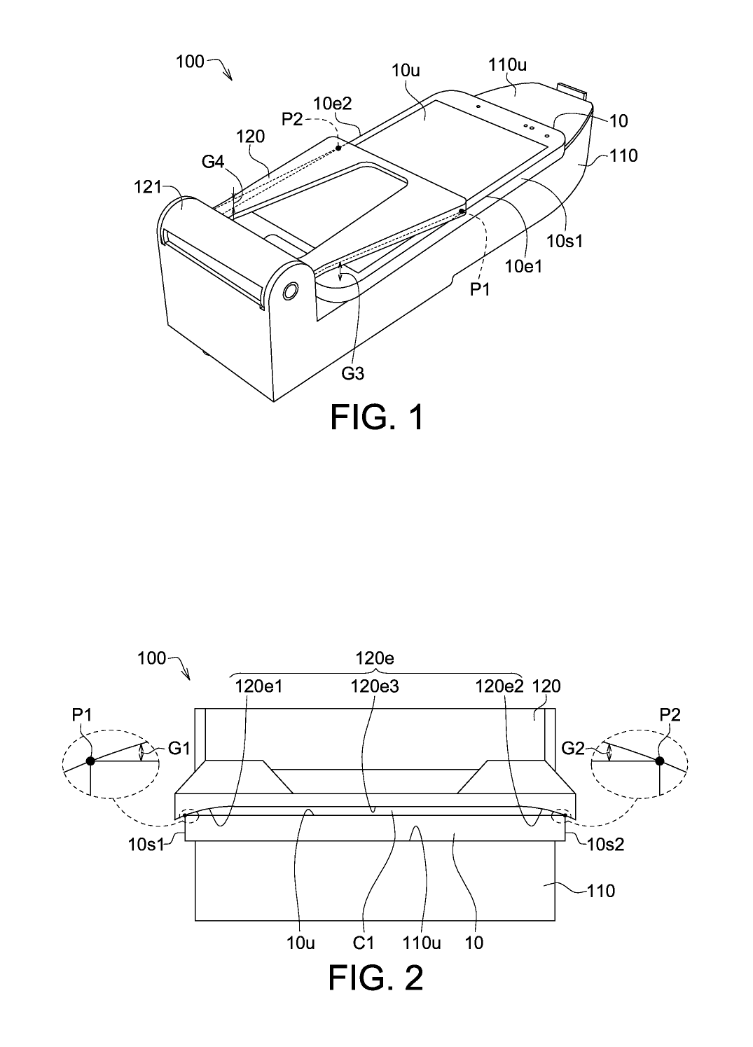

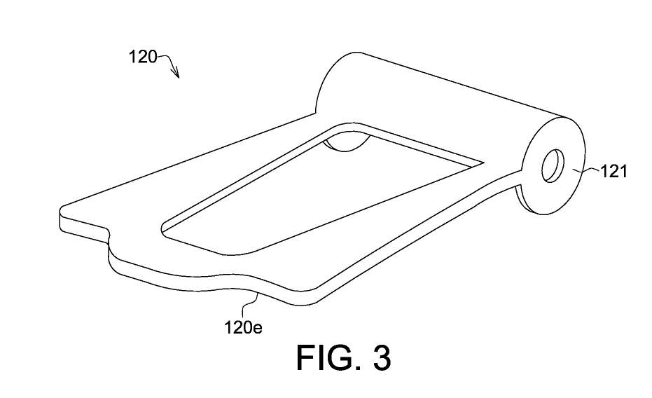

Refer to FIGS. 1, 2 and 3, FIG. 1 illustrates a schematic diagram of a clamp device according to an embodiment of the invention, FIG. 2 illustrates a side view of the clamp device of FIG. 1, and FIG. 3 illustrates a schematic diagram of a clamp of the clamp device of FIG. 1.

The clamp device 100 may be applied on vehicles, home appliances, consumer electronics or medical systems. The clamp device 100 comprises a compartment 110 and a clamp 120. The compartment 110 is used for carrying a communication device 10. The communication device 10 has a flat-surface 10u, a first lateral surface 10s1 and a second lateral surface 10s2 (shown in FIG. 2) opposite to the first lateral surface 10s1. In the present embodiment, the communication device 10 is disposed on the flat-surface 10u, and the flat-surface 10u is a display surface of the communication device 10, for example. The first lateral surface 10s1 connects the flat-surface 10u by a first surface edge 10e1. The second lateral surface 10s2 (shown in FIG. 2) connects the flat-surface 10u by a second surface edge 10e2.

As shown in FIG. 1, the compartment 110 has a coplanar 110u for carrying the communication device 10, and accordingly the size of the communication device 10 is not limited by the compartment 110. In detail, any size of the communication device 10, such as a smartphone or a cellphone, may be easily placed on the coplanar 110u of the compartment 110, even if the size of the communication device 10 is larger than the area of the coplanar 110u.

As shown in FIGS. 1 and 3, the clamp 120 comprises a pivotal portion 121 pivotally connected to the compartment 110. In the present embodiment, the clamp 120 is pivotally connected to a back of the compartment 110, but not limited to. In another embodiment, the clamp 120 may be pivotally connected to any portion of the compartment 110

As shown in FIG. 2, the clamp 120 has a pressing line 120e. The pressing line 120e may contact a first surface edge 10e1 (shown in FIG. 1) and a second edge 10e2 (shown in FIG. 1) of the flat-surface 10u of the communication device 10 to fix the communication device 10 on the compartment 110 for fixing a relative position between the compartment 110 and the communication device 10. In one embodiment, the clamp device 100 further comprises a torsion spring (not shown in the figures) connecting the clamp 120 and the compartment 110, such that the clamp 120 may provide the communication device 10 with a press force, generated by the torsion spring, for fixing a relative position between the compartment 110 and the communication device 10.

In the present embodiment, the pressing line 120e contacts the flat-surface 10u of the communication device 10 by a way of point to point. In detail, the pressing line 120e comprises a first line 120e1, a second line 120e2 and a connection line 120e3 connecting the first line 120e1 and the second line 120e2. The first line 120e1 contacts the first surface edges 10e1 in a first contact point P1, and the second line 120e2 contacts the second surface edges 10e2 in a second contact point P2.

As shown in FIG. 2, a first gap G1 between the first line 120e1 and the first surface edge 10e1 is getting larger from the first contact point P1 toward the connection line 120e3. Similarly, a second gap G2 between the second line 120e2 and the second surface edge 10e2 is getting larger from the second contact point P2 toward the connection line 120e3. Accordingly, the flat-surface 10u of the communication device 10 may be prevented from being scratched by the clamp 120.

As shown in FIG. 2, in one embodiment, the first line 120e1 is a curved line, the second line 120e2 is a curved line and the connection line 120e3 is a straight line, but not limited to. In other embodiments, at least one of the first line 120e1, the second line 120e2 and the connection line 120e3 is curved line or straight line. In other embodiment, the entire pressing line 120e is a curved line having the same curvature or a variety of curvature. All radii or slopes of the pressing line 120e are covered by the embodiment of this invention. In one embodiment, the curvature may be square or along a major axis of the clamp 120.

As shown in FIG. 1, a third gap G3 between the clamp 120 and the communication device 10 is getting larger from the first contact point P1 toward the pivotal portion 121 of the clamp 120; accordingly, the flat-surface 10u of the communication device 10 may be prevented from being scratched by the clamp 120. Similarly, a fourth gap G4 between the clamp 120 and the communication device 10 is getting larger from the second contact point P2 to the pivotal portion 121 of the clamp 120.

Since the design of the gaps G1, G2, G3 and G4, a cavity C1 (shown in FIG. 2) is formed between the clamp 120 and the communication device 10, and accordingly the flat-surface 10u of the communication device 10 may be prevented from being scratched by the clamp 120.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A clamp device for carrying a communication device, comprising:
a compartment; and
a clamp pivotally connected to the compartment and having a pressing line for contacting a surface edge of the communication device to fix the communication device on the compartment.

2. The clamp device according to claim 1, wherein the pressing line contacts the communication device by a way of point to point.

3. The clamp device according to claim 1, wherein the pressing line is a curved line.

4. The clamp device according to claim 1, wherein the pressing line is a straight line.

5. The clamp device according to claim 1, wherein the pressing line comprises a first line, a second line and a connection line connecting the first line and the second line, wherein the first line and the second line contact two opposite surface edges of the communication device respectively.

6. The clamp device according to claim 5, wherein the first line contacts the surface edge in a first contact point, a first gap between the first line and the surface edge is getting larger from the first contact point toward the connection line.

7. The clamp device according to claim 5, wherein the second line contacts the surface edge in a second contact point, a second gap between the second line and the surface edge is getting larger from the second contact point toward the connection line.

8. The clamp device according to claim 5, wherein at least one of the first line, the second line and the connection line is curved line or straight line.

9. The clamp device according to claim 1, wherein a third gap between the clamp and the communication device is getting larger from a contact point between the pressing line and the surface edge toward a pivotal portion of the clamp pivotally connecting to the compartment.

10. The clamp device according to claim 1, wherein the compartment has a coplanar for carrying the communication device.
